(19) United States
(12) Patent Application Publication
(10) Pub. No.: US 2006/0102822 A1
(43) Pub. Date: May 18, 2006

(54) Adjustable flagpole seat assembly

(76) Inventor: Yung Lin Liang, Yung-Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/989,377

(22) Filed: Nov. 17, 2004

(51) Int. Cl. F16M 13/00

(52) U.S. Cl. 248/514

(57) ABSTRACT

An adjustable flagpole seat assembly includes a seat, a pivotable member in pivotal connection with a wall on the seat, and a flagpole holding member mounted on the pivotable member to pivot therewith. The pivotable member is positioned by at least one positioning member in a desired angular position relative to the wall. The pivotable member includes at least two retaining grooves in a circumference thereof, and a locking rod is selectively engaged with one of the retaining grooves.

### BACKGROUND OF THE INVENTION

1. Field of the Invention

The present invention relates to a flagpole seat assembly. In particular, the present invention relates to an adjustable flagpole seat assembly that allows adjustment of a tilt angle of a flagpole holding member.

2. Description of the Related Art

A flag is usually a sign of a country, organization, etc. The flagpole of the flag is sometimes placed on a seat. In a conventional design, the seat includes a wall with a plurality of teeth in a side thereof. A disc includes a plurality of teeth on a side thereof for engaging with the teeth of the wall. A screw is extended through a hole in the disc and a hole in the wall and then engaged with a nut, thereby fixing the disc in a desired tilt angle. A flagpole is held by a flagpole holding member mounted on a circumference of the disc. In adjustment, the screw has to be completely disengaged from the disc and the wall for subsequent pivotal movement of the disc relative to the wall. When the disc reaches the desired tilt angle, the screw is extended through the disc and the wall and reengages with the nut again. The adjusting procedure is troublesome and time-consuming. Further, the flagpole might fall when the screw is disengaged from the disc and the wall, as the flagpole is not supported.

### SUMMARY OF THE INVENTION

In accordance with an aspect of the present invention, an adjustable flagpole seat assembly comprises a seat, a pivotable member in pivotal connection with a wall on the seat, and a flagpole holding member mounted on the pivotable member to pivot therewith. The pivotable member is positioned by at least one positioning member in a desired angular position relative to the wall. The pivotable member includes at least two retaining grooves in a circumference thereof, and a locking rod is selectively engaged with one of the retaining grooves.

A plate may be fixed to the wall and include a through-hole through which the locking rod extends. The locking rod includes a first end and a second end respectively on two sides of the plate. The locking rod further includes a flange received in the through-hole. An elastic element is mounted in the through-hole of the plate and has an end abutting against the flange for biasing the first end of the locking rod into a selected one of the retaining grooves.

In an embodiment of the invention, the locking rod includes a retaining plate fixed on the first end of the locking rod for releasably engaging with the selected one of the retaining grooves.

The pivotable member includes at least two positioning grooves in a side thereof. The wall includes at least one hole in a side thereof. A ball is received in the at least one hole of the wall, and an elastic element is mounted in the at least one hole of the wall for biasing the ball partially into a selected one of the positioning grooves.

A grip member may be fixed to the second end of the locking member, allowing manually pulling the retaining plate of the locking rod out of the retaining grooves.

In accordance with another aspect of the invention, an adjustable flagpole seat assembly comprises a seat including two walls having a space therebetween, a pivotable member pivotally mounted in the space between the walls, and a flagpole holding member mounted on the pivotable member to pivot therewith. The pivotable member is positioned by at least one positioning member in a desired angular position relative to the wall The pivotable member includes a plurality of retaining grooves in a circumference thereof, and a locking rod is selectively engaged with one of the retaining grooves.

The flagpole may be moved to a desired tilt angle through easy, safe operation.

Other objectives, advantages, and novel features of the invention will become more apparent from the following detailed description when taken in conjunction with the accompanying drawings.

### BRIEF DESCRIPTION OF THE DRAWINGS

FIG. 1 is an exploded perspective view of an adjustable flagpole seat assembly in accordance with the present invention.

FIG. 2 is a perspective view of the adjustable flagpole seat assembly in accordance with the present invention.

FIG. 3 is a sectional view of the adjustable flagpole seat assembly in accordance with the present invention.

FIG. 4 is another sectional view of the adjustable flagpole seat assembly in accordance with the present invention.

FIG. 5 is a view similar to FIG. 4, illustrating adjustment in the tilt angle of a flagpole holding member.

FIGS. 6 and 7 are sectional views similar to FIG. 3, illustrating different tilt angles of the flagpole holding member.

### DETAILED DESCRIPTION OF THE PREFERRED EMBODIMENT

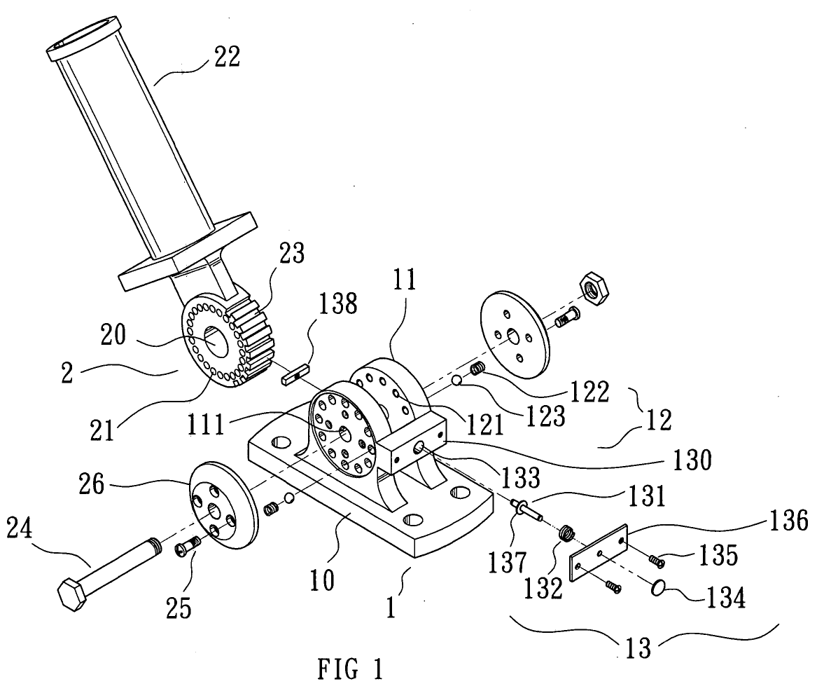

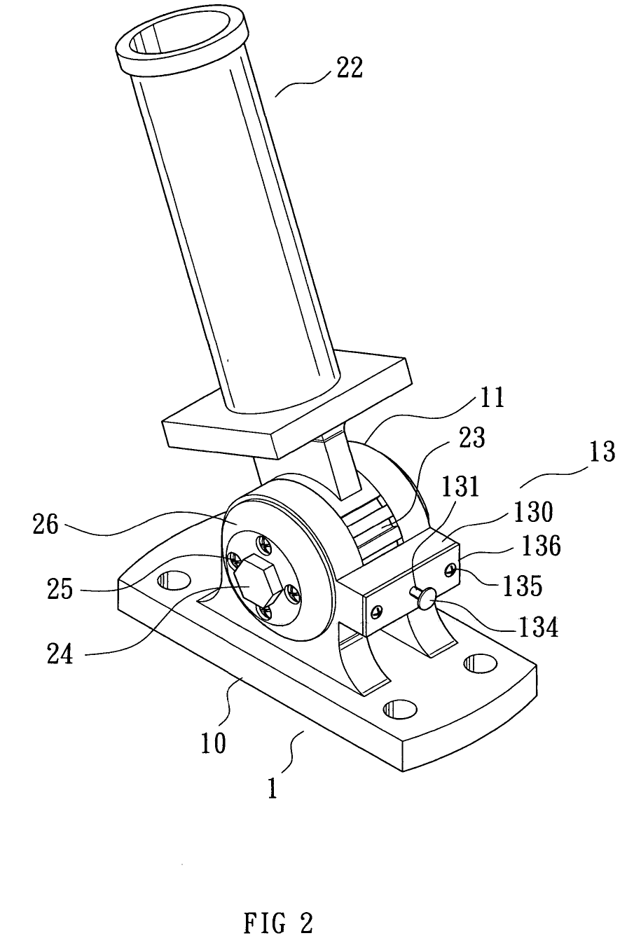

Referring to FIGS. 1 and 2, an adjustable flagpole seat assembly in accordance with the present invention comprises a base 1 and a pivotable member 2 pivoted to the base 1. The base 1 includes a seat 10 on which at least one wall 11 is formed. In the illustrated embodiment, two spaced walls 11 are formed on the seat 10. At least one positioning means 12 is provided on an inner side of each wall 11. In this embodiment, each wall 11 includes a plurality of grooves 121, a ball 123 mounted in each groove 121, and an elastic element 122 mounted in each groove 121 for biasing the ball 123 partially out of the associated groove 121.

The pivotable member 2 is pivotally mounted between a space between the walls 11. In the illustrated embodiment, the pivotal member 2 includes a through-hole 20 extending from a first side thereof through a second side thereof. A pin 24 is extended through aligned holes 111 in the walls 11 and the through-hole 20 of the pivotable member 2, allowing pivotal movement of the pivotable member 2 relative to the walls 11. Side covers 26 may be mounted by fasteners 25 to outer sides of the walls 11.

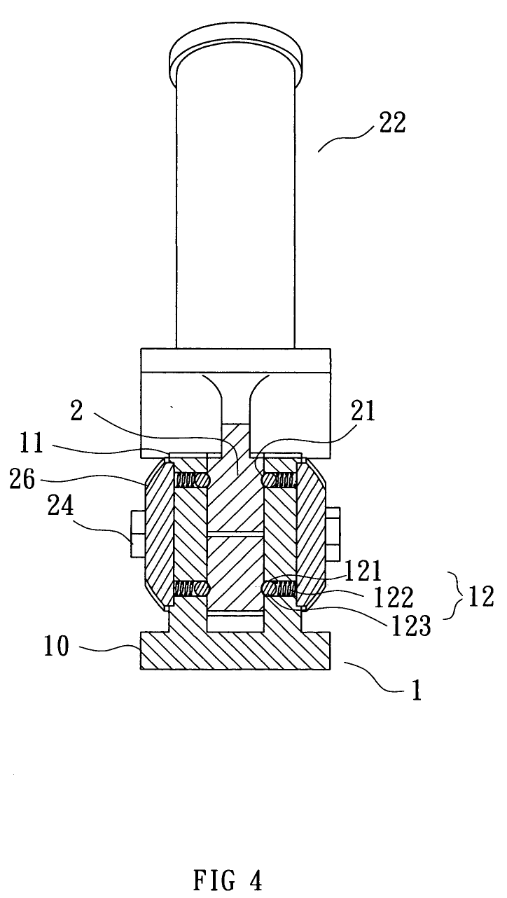

Further, a plurality of positioning grooves 21 (shallow grooves in this embodiment) are defined in each of the first side and the second side of the pivotal member 2 and respectively aligned with the grooves 121 of the walls 11. As illustrated in FIG. 4, each ball 123 is biased by an associated elastic element 122 into an associated positioning groove 21. The pivotable member 2 further includes at least two retaining grooves 23 in a circumference thereof. A flagpole holding member 22 is mounted on the pivotal member 2 to pivot therewith. The flagpole holding member 22 includes a hole (not labeled) for receiving a lower end of a flagpole (not shown).

A retaining device 13 is provided for retaining the pivotal member 2 in the desired tilt angle relative to the seat 10. In the illustrated embodiment, the retaining device 13 includes a connecting plate 130 having two ends respectively fixed to the peripheries of the walls 10. A cover plate 136 is fixed by fasteners 135 to an outer side of the plate 130. A locking rod 131 extends through a through-hole 133 of the plate 130 and includes a first end and a second end that are respectively on two sides of plate 130. A retaining plate 138 is fixed to the first end of the locking rod 131 for engaging with one of the retaining grooves 23. A grip member 134 is fixed to the second end of the locking rod 131 to allow manual grip. The locking rod 131 further includes a flange 137 received in the through-hole 133 of the plate 130. Also mounted in the through-hole 133 of the plate 130 is an elastic element 132 having a first end abutting against the cover plate 136 and a second end abutting against the flange 137, biasing the retaining plate 138 into the selected retaining groove 23 of the pivotal member 2, thereby retaining the pivotal member 2 and the flagpole holding member 22 in the desired tilt angle.

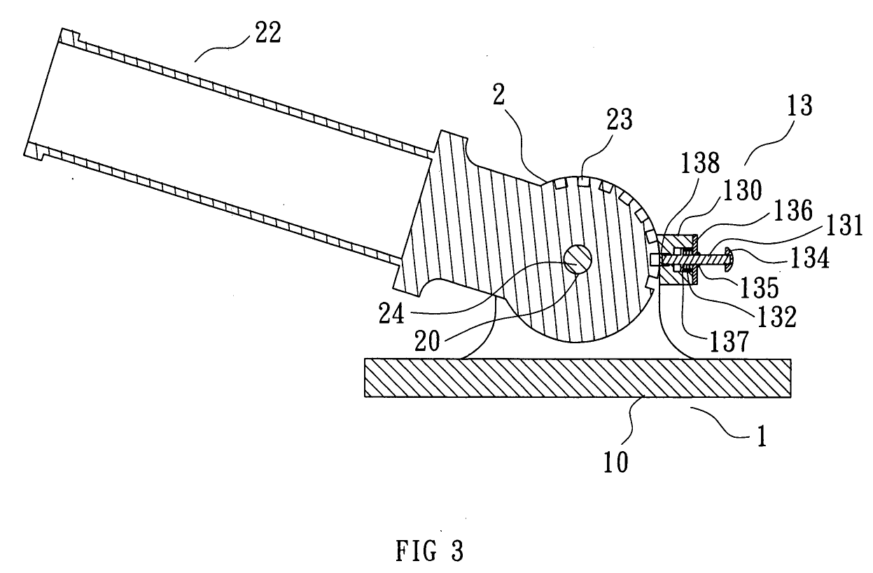

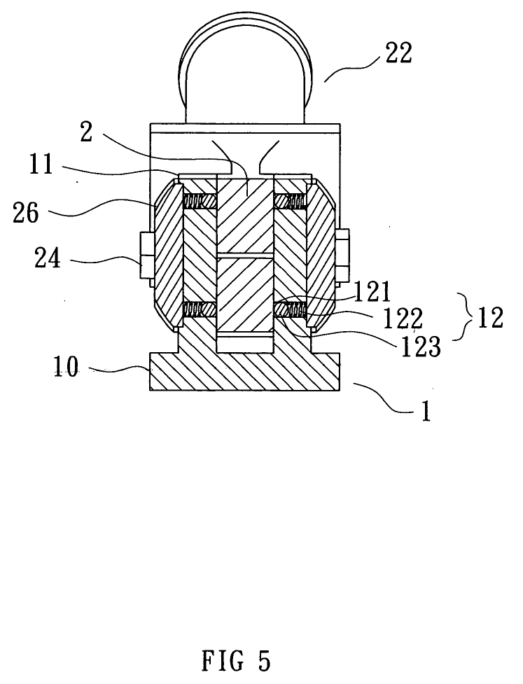

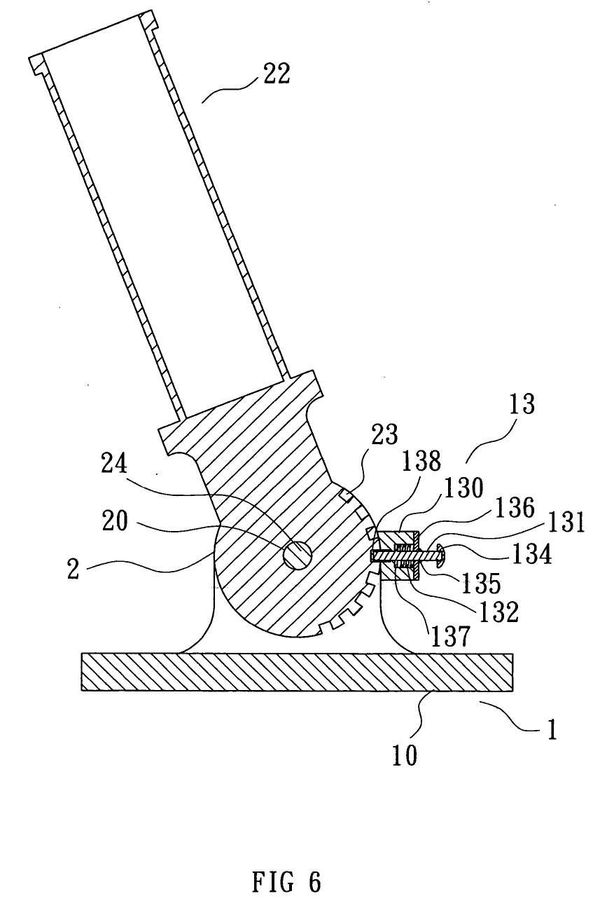

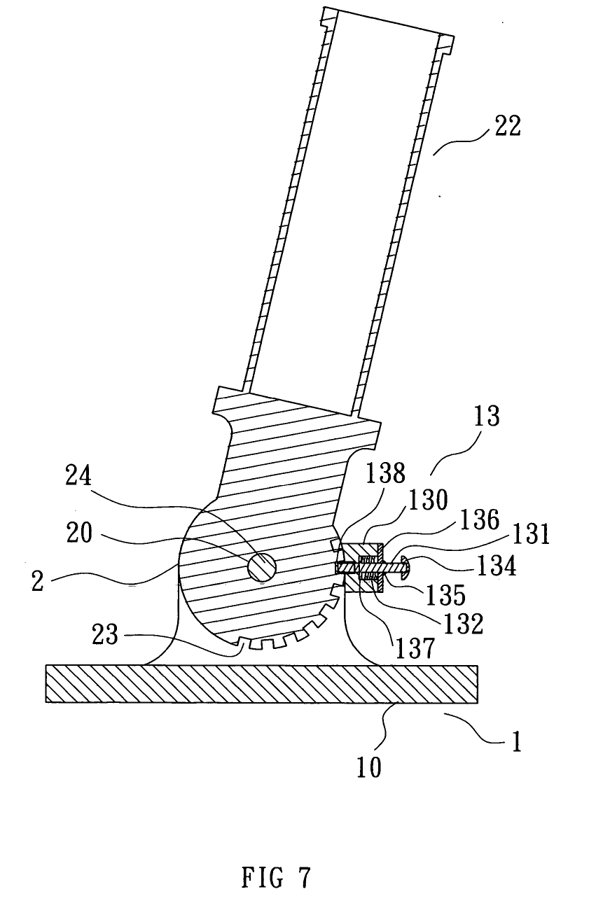

When adjusting the tilt angle of the flagpole holding member 22, the grip member 134 is pulled outward to disengage the retaining plate 138 from the retaining grooves 23, as shown in FIG. 3. Referring to FIGS. 4 and 5, the pivotable member 2 is pivoted to a desired tilt angle (see FIG. 6 and FIG. 7), and the grip member 134 is then released. The retaining plate 138 is engaged with another retaining groove 23 under the action of the elastic element 132. It is noted that since the positioning grooves 21 of the pivotable member 2 are shallow, each ball 121 is retracted from an associated positioning groove 21 into an associated groove 121 of the associated wall 11 when the pivotable member 2 is pivoted, as shown in FIG. 5. When the pivotable member 2 reaches the desired tilt angle, each ball 121 is biased by the associated elastic element 122 into another positioning groove 21 of the pivotable member 2, providing an additional positioning effect for the pivotable member 2 while the retaining member 138 is disengaged from the retaining grooves 23.

As apparent from the foregoing, the flagpole holding member 22 of the present invention can be easily moved to a desired tilt angle and reliably retained in place. Further, the positioning means 12 provides a positioning effect for the pivotable member 2 to prevent the flagpole from falling when the retaining member 138 is disengaged from the retaining grooves 23.

Although a specific embodiment has been illustrated and described, numerous modifications and variations are still possible without departing from the essence of the invention. The scope of the invention is limited by the accompanying claims.

What is claimed is:

1. An adjustable flagpole seat assembly comprising:
a seat including a wall;
a pivotable member in pivotal connection with the wall, the pivotable member including at least two retaining grooves in a circumference thereof;
a flagpole holding member mounted on the pivotable member to pivot therewith;
at least one positioning member for positioning the pivotable member in a desired angular position relative to the wall; and
a locking rod selectively engaged with one of said at least two retaining grooves.

2. The adjustable flagpole seat assembly as claimed in claim 1 further comprising a plate fixed to the wall, the plate including a through-hole through which the locking rod extends, the locking rod including a first end and a second end respectively on two sides of the plate, the locking rod further including a flange received in the through-hole, an elastic element being mounted in the through-hole of the plate and having an end abutting against the flange for biasing the first end of the locking rod into a selected one of said at least two retaining grooves.

3. The adjustable flagpole seat assembly as claimed in claim 1 wherein the locking rod includes a retaining plate fixed on the first end of the locking rod for releasably engaging with the selected one of said at least two retaining grooves.

4. The adjustable flagpole seat assembly as claimed in claim 1 wherein the pivotable member including at least two positioning grooves in a side thereof, the wall including at least one hole in a side thereof, a ball being received in said at least one hole of the wall, an elastic element being mounted in said at least one hole of the wall for biasing said ball partially into a selected one of said at least two positioning grooves.

5. The adjustable flagpole seat assembly as claimed in claim 3 further including a grip member fixed to the second end of the locking member, allowing manually pulling the retaining plate of the locking rod out of said at least two retaining grooves.

6. An adjustable flagpole seat assembly comprising:
a seat including two walls having a space therebetween;
a pivotable member pivotally mounted in the space between the walls, the pivotable member including a plurality of retaining grooves in a circumference thereof;
a flagpole holding member mounted on the pivotable member to pivot therewith;
at least one positioning member for positioning the pivotable member in a desired angular position relative to the wall; and
a locking rod selectively engaged with one of the retaining grooves.

7. The adjustable flagpole seat assembly as claimed in claim 6 further comprising a plate including two ends respectively fixed to the walls, the plate including a through-hole through which the locking rod extends, the locking rod including a first end and a second end respectively on two sides of the plate, an elastic element being mounted in the through-hole of the plate for biasing the first end of the locking rod into a selected one of the retaining grooves.

8. The adjustable flagpole seat assembly as claimed in claim 7 further including a cover plate mounted to an outer side of the plate, the elastic element including a first end abutting against the cover plate and a second end abutting against the flange.

9. The adjustable flagpole seat assembly as claimed in claim 6 wherein the locking rod includes a retaining plate fixed on the first end of the locking rod for releasably engaging with the selected one of the retaining grooves.

10. The adjustable flagpole seat assembly as claimed in claim 6 wherein the pivotable member including a plurality of positioning grooves in a side thereof, one of the walls including at least one hole in a side thereof, a ball being received in said at least one hole of the wall, an elastic element being mounted in said at least one hole of the wall for biasing said ball partially into a selected one of the positioning grooves.

11. The adjustable flagpole seat assembly as claimed in claim 10 wherein the ball is retracted from said at least one hole of said one of the walls when the pivotable member is pivoted, and wherein the ball is biased by the elastic element into one of the positioning grooves when the pivotable member is in a desired tilt angle.

12. The adjustable flagpole seat assembly as claimed in claim 6 wherein the pivotable member including a plurality of positioning grooves in each of two sides thereof, each said wall including a plurality of holes in a side thereof, a ball being received in each said hole of each said wall, an elastic element being mounted in each said hole of each said wall for biasing an associated one of the balls partially into an associated one of the positioning grooves.

13. The adjustable flagpole seat assembly as claimed in claim 12 wherein each said ball is retracted from an associated one of the holes when the pivotable member is pivoted, and wherein each said ball is biased by the elastic element into an associated one of the positioning grooves when the pivotable member is in a desired tilt angle.

14. The adjustable flagpole seat assembly as claimed in claim 9 further including a grip member fixed to the second end of the locking member, allowing manually pulling the retaining plate of the locking rod out of the retaining grooves.
